(19) United States
(12) Patent Application Publication
(10) Pub. No.: US 2006/0286024 A1
(43) Pub. Date: Dec. 21, 2006

(54) Synthesis and cleaving of carbon nanochips

(76) Inventors: R. Terry K. Baker, Pittsboro, NC (US); Nelly M. Rodriguez, Pittsboro, NC (US)

Correspondence Address: KEAN, MILLER, HAWTHORNE, D'ARMOND,;MCCOWAN & JARMAN, L.L.P., ONE AMERICAN PLACE, 22ND FLOOR, P.O. BOX 3513, BATON ROUGE, LA, 70821, US

(21) Appl. No.: 11/453,601

(22) Filed: Jun. 15, 2006

Related U.S. Application Data
(60) Provisional application No. 60/690,635, filed on Jun. 15, 2005.

(51) Int. Cl. D01F 9/12; C01B 31/04

(52) U.S. Cl. 423/447.1; 423/448

(57) ABSTRACT

A unique graphite nanostructure and method of manufacture. The method comprises the cleavage of carbon nanofibers into sections having widths in the range 0.34 to 3.02 nm. The spacing between the inner adjacent walls of all the resulting nanochips is fixed at a distance of 0.34 nm. These cleaved sections are suitable for incorporation into polymers to provide high electrical conductivity or dispersed on conductive substrates for a variety of electronic applications.

### CROSS-REFERENCE TO RELATED APPLICATIONS

This application is based on Provisional Application 60/690,635 filed on Jun. 15, 2005.

### FIELD OF THE INVENTION

This invention relates to a method for the synthesis and subsequent cleavage of carbon nanochips into sections having widths in the range 0.34 to 3.02 nm. The spacing between the inner adjacent walls of all the nanochips is fixed at a distance of 0.34 nm. These cleaved sections are suitable for incorporation into polymers to provide high electrical conductivity or dispersed on conductive substrates for a variety of electronic applications.

### BACKGROUND OF THE INVENTION

Carbon nanostructures have attracted considerable attention in recent years because of their unique physical, electronic and chemical properties that make them ideal candidates for use in a broad range of potential nano-devices. Most of these applications will require a fabrication method capable of producing uniform carbon nanostructures with well-defined sizes and controllable, reproducible properties. In the case of electronic and photonic devices such as field emission displays (FED), electromagnetic interference/radiofrequency interference (EMI/RFI) and data storage there is a requirement that the nanostuctures be present in an aligned arrangement. While it has been possible to construct isolated bundles of arrays of carbon nanotubes, the ability to control the dimensions and spacing of such structures over an extended area of a surface still remains a difficult challenge.

In recent years, flat panel display devices have been developed and widely used in electronic applications, such as high definition television and personal computers. One type of flat panel display device is an active matrix liquid crystal system that provides improved resolution. Unfortunately, the liquid crystal display device has inherent limitations that render it unsuitable for a number of applications. For example, liquid crystal displays have numerous fabrication limitations including a slow deposition process for coating a glass panel with amorphous silicon, high manufacturing complexity and low yield for the fabrication process. Furthermore, liquid crystal display devices require a fluorescent backlight that draws a relatively high amount of power, while most of the light that is generated is wasted.

It is possible to overcome these shortcomings by the use of field emission display (FED) devices, which have a higher contrast ratio, larger viewing angles, higher maximum brightness, lower power consumption and wider operating temperature range than liquid crystal displays. In a FED, electrons are emitted from a cathode and impinge on high sensitivity phosphors on the back of a transparent cover plate to produce an image. This phenomenon is referred to as a cathodoluminescent process and is known to be the most efficient method for generating light. Contrary to a conventional cathode ray tube device, each pixel, or emission unit in a FED has its own electron source that is typically an array of emitting microtips. A voltage difference that exists between the cathode and a gate extracts electrons from the former and accelerates them towards the phosphor coating on the back of the transparent cover plate. The emission current, and thus the display brightness, is strongly dependent upon the work function of the emitting material. In order to achieve the necessary efficiency of a FED, the cleanliness and uniformity of the emitter source materials are key factors.

The conventional FED devices based on microtips produces a flat panel display device of improved quality when compared to liquid crystal display systems. A major disadvantage of the microtip FED device is the complicated processing steps that must be used to fabricate the device. Such as described in U.S. Pat. No. 6,359,383, which is incorporated herein by reference. For example, the formation of the various layers in the device, and specifically the formation of microtips, requires a thin film deposition technique utilizing a photolithographic method. As a result, numerous photo-masking steps must be performed in order to define and fabricate the various structural features in the FED. The chemical vapor deposition processes and the photolithographic processes involved greatly increases the manufacturing costs of a FED device.

An attempt has been made to overcome problems associated with conventional microtip technology in U.S. Pat. No. 6,359,383, which discloses the use of carbon nanotubes as the emitter layer instead of microtips. The inventions hereof have found that the use of nanotubes presents its own set of problems. For example, when carbon nanotubes are deposited onto a substrate surface, they tend to lay down parallel to instead of perpendicular to the substrate surface. This is a problem because in order for the nanotubes to function as electron emitters the arrangement of the graphite sheets constituting the nanotubes must be substantially perpendicular to the substrate surface. This problem can be partially overcome according to U.S. Pat. No. 6,361,861 to Gao et al., which discloses a method for the synthesis of well aligned carbon nanotubes filled with a conductive filler grown in a perpendicular direction on a conductive substrate. While this method will generate carbonaceous nanostructures, the distribution is typically not homogeneous. Other problems include the uniformity of the spacing between adjacent tubes, which to a large degree is controlled by the initial dispersion of the metal catalyst particles responsible for generating the carbon nanotubes. Further, there is a high cost associated with the production and purification of carbon nanotubes that are suitable for this application.

At present there no high conductivity polymer fibers available for use in EMI/RFI protection applications (resistivity about 10³ to 10⁶ ohms per square). The resistivity requirements for a polymer fiber to function for electrostatic discharge and anti-static discharge are less stringent, being in the range 10⁶ to 10⁹ ohms per square and 10⁶ to 10¹² ohms per square, respectively. Currently, ant-static fibers and yams are generally produced in a bi-component melt spinning process where the conductive component is a blend of a thermoplastic polymer such as nylon or polyester containing a high loading of carbon black powder. The high loading of carbon black powder in the conductive component is necessary to ensure that the individual particles make physical contact with one another in order to provide a continuous conductive pathway. The critical loading of a conductive component in the fiber that results in a sharp increase in the conductivity is referred to as the “percolation limit”. The percolation limit for carbon black is 30-32 wt.%, depending upon the specific polymer in which it is dispersed. At such high loadings, the carbon black particles tend to form agglomerates that either become entrapped in the filtering media, the small spinneret holes through which the fibers are spun, or within the molten fiber itself, resulting in thread-like breaks and otherwise poor melt spinning and drawing performance. Furthermore, the conductivity of the fiber is substantially reduced during the subsequent drawing step because the carbon particles tend to become isolated from the formed “chain”. This results in a decrease in the fiber conductivity by about one hundred times.

U.S. Pat. No. 5,098,771 to Friend teaches the incorporation of carbon fibrils, also known as multi-walled carbon nanotubes (MWNT) into polymeric binders to form electrically conductive composites for use in coatings and inks. The fibrils are described as being essentially cylindrical tubes having graphitic layers that are substantially parallel to the fibril axis. The fibrils preferably have diameters between 3.5 and 70 nm and a length to diameter ratio of at least 5.

Iijima et al. (Nature, Vol. 363, p. 603 (1993) first reported the existence of single-walled carbon nanotubes (SWNT). At about the same time, Bethune et al. discovered that SWNT could be synthesized via a metal catalyzed process (Bethune et al. Nature, Vol. 363, p. 605 (1993) and U.S. Pat. No. 5,424,054. The thinnest SWNT was 0.75 nm in diameter with an average value of 1.2 nm diameter and lengths of up to 700 nm.

We have unexpectedly discovered that when “platelet” graphite nanofibers are subjected to a high temperature treatment from 1100° to 3000° C. in an inert gas environment, the edge regions of such materials undergo reaction that produces the fusion of adjacent layers and resulting in a “sealing action” of up to 10 neighboring graphite layers. These structures form folds of two, four, six, eight or ten walls. When these modified “platelet” graphite nanofibers (carbon nanochips) are subsequently cleaved into smaller sections the resulting “chips” or slabs have cross-sectional dimensions in the range, 0.34 to 3.02 nm, where the lower limit width is significantly narrower than that of traditional SWNT. The average width of the “chips” is dependent upon the temperature at which the precursor “platelet” graphite nanofibers are treated. On the other hand, the distance between the inner adjacent walls of the nanochips is fixed at a distance of 0.34 nm, which is narrower than any other known carbon nanostucture. Consequently, these materials are considered as a new composition of matter.

### SUMMARY OF THE INVENTION

In a preferred embodiment, the graphite nanostructure is one wherein the graphite platelets are aligned substantially perpendicular to the longitudinal axis of the nanostructure and have been treated in an inert gas to a temperature over the range 1100 to 3000° C.

In the most preferred embodiment the temperature range is from 1800 to 3000° C.

In accordance with the present invention, there is provided a method for the production of highly conductive carbon nanochips comprised of a structure in which the walls are aligned in a direction parallel to the longitudinal axis and are separated by a fixed distance of 0.34 nm and the overall width of such structures can vary from 0.35 to 3.02 nm and having a crystallinity of greater than 99.5%.

In the preferred embodiment, the external width or cross-sectional dimension of the carbon nanochips is about 0.35 to 3.02 nm.

In the most preferred embodiment, the external width or cross-sectional dimension of the carbon nanochips is about 0.35 to 0.75 nm.

### DETAILED DESCRIPTION OF THE INVENTION

The carbon nanochips of the present invention are themselves comprised of a plurality of graphite platelets, also sometimes called graphite sheets, that are aligned, substantially perpendicular, or at an angle, to the longitudinal (growth) axis of the nanofiber. It is preferred that the graphite sheets be aligned substantially perpendicular to the longitudinal axis. By “at an angle” we mean that the graphite platelets are aligned so that they are neither parallel nor perpendicular to the longitudinal axis of the nanofiber. For example they can be from about 1° to about 89°, preferably from about 10° to about 80°, more preferably from about 20° to about 70°, and most preferably from about 30° to about 60° with respect to the longitudinal axis of the nanofiber. In the case where the graphitic sheets are oriented substantially perpendicular to the growth axis, the graphite nanofibers are sometimes referred to as “platelet”. In the case where the graphitic sheets are oriented at an angle to the growth axis are sometimes referred to as “herringbone”. The term “carbon” is sometimes used interchangeably with “graphite” herein and the word “nanostucture” is sometimes used interchangeably with “nanofiber” herein.

The carbon nanochips of the present invention are novel materials having a unique set of properties that include: (i) a surface area from about 20 to 50 m²/g, preferably from about 30 to 45 m²/g, more and most preferably from about 35 to 40 m²/g, which surface area is determined by N₂ adsorption at −196° C.; (ii) a crystallinity from about 5% to about 100%, preferably from about 50% to 100%, more preferably from about 75% to 100%, most preferably from about 90% to 100%, and ideally substantially 100%; (iv) an average pore size from about 10 to 15 nm, most preferably from about 11 to 13 nm and ideally 12 nm, and (iii) interstices of about 0.34 nm to about 0.40 nm, preferably about 0.34 nm. The surface area of the carbon nanochips can be decreased by heat treatment in an inert gas environment, such as argon at a temperature of between 1500 and 3000° C., preferably from about 1800 to 3000° C. and most preferably from 2000 to 3000° C. The interstices are the distance between the graphite platelets. The shape of the nanochips can be any suitable shape. Non-limiting examples of preferred shapes include straight, branched, twisted, spiral, helical, and coiled.

The precursor “platelet” graphite nanofibers used to produce the carbon nanochips of the present invention possess a novel structure in which the graphite sheets constituting the material are aligned in a direction that is substantially perpendicular to the fiber growth axis (longitudinal axis). In addition, the nanofibers have a unique set of properties, which include: (i) an average width from about 60 to 75 nm; (ii) a nitrogen surface area from about 130 to 250 m²/g; (iii) a crystallinity from about 98% to 100%; (iv) a spacing between adjacent graphite sheets of 0.34 nm to about 0.67 nm, and more preferably from about 0.34 nm to about 0.338 nm.

A variety of catalyst systems can be used to prepare the precursor “platelet” graphite nanofibers of the present invention including one process taught in U.S. Pat. No. 6,537,515B1 to Baker et al. wherein an iron-copper bimetallic bulk catalyst is reacted with a mixture of CO and H₂ at temperatures from about 550 to 670° C. In a another process the “platelet” graphite nanofibers can be generated from the interaction of a copper-nickel-magnesium oxide catalyst with CH₄ temperatures ranging from 600 to 800° C. (H. Wang et al. U.S. Patent Application). In yet a further process, the same type of nanofibers can be grown from the decomposition of CO/H₂ mixtures over a iron/magnesium oxide catalyst at 500 to 700° C.

The average powder particle size of the catalyst will range from about 50 nm to about 5 microns, preferably from about 250 nm to about Imicron. In one procedure the ratios of Ni to Cu and the metals to magnesium oxide can be any effective ratios that will produce substantially crystalline graphite nanofibers in which the graphite sheets are substantially perpendicular to the longitudinal fiber axis, the average width of the nanofibers from about 33 nm to about 55 um and the surface area from about 130 to 250 m²/g when the catalyst is heated from about 600 to about 800° C., preferably from about 665 to 760° C. and most preferably from 665 to 700° C. in methane. The ratio of Ni to Cu will typically be from about 9:1 to 1:1, with the most preferred Ni to Cu ratio being from about 4:1 to about 3:2. The ratio of total metals to magnesium oxide is typically from about 0.6:1 to about 3.6:1 and preferably from about 1.8:1 to about 3.6:1 and most preferably 2.4:1

In another method of preparation of “platelet” graphite nanofibers a CO/H₂ mixture is passed over a Fe/MgO catalyst. The ratios of Fe to magnesium oxide can be any effective ratios that will produce substantially crystalline graphite nanofibers in which the graphite sheets are substantially perpendicular to the longitudinal fiber axis, the average width of the nanofibers from about 60 nm to about 75 nm and the surface area from about 100 to 150 m²/g when the catalyst is heated from about 500 to about 700° C., preferably from about 550 to 650° C. and most preferably from 580 to 630° C. in a CO/H₂ mixture. The ratio of Fe to magnesium oxide is typically from about 0.56:1 to about 49:1 and preferably from about 0.92:1 to about 24:1 and most preferably 2.6:1 to 24:1.

A preferred method for preparing the Ni_{X}Cu_{Z}Mg_{Y}O and Fe/MgO catalysts of the present invention is that of the evaporative precipitation method. This procedure is outlined below:

Step 1: A mixture of nickel nitrate, copper nitrate and magnesium nitrate in the desired ratios or a mixture of iron nitrate and magnesium nitrate in the desired ratios is initially dissolved in ethanol to form a homogeneous solution.

Step 2: The solution is then subjected to evaporation to form a concentrated solution by vigorous stirring at room temperature.

Step 3: The evaporation process is continued as the temperature is raised up to 150° C. while simultaneously maintaining the stirring action until a solid mass of homogeneously mixed nitrates is obtained.

Step 4: The solid mixture is then calcined in flowing air at 500° C. for a period of at least 4 hours to convert the metal nitrates into metal oxides.

Step 5: The calcined sample is then ground in a ball mill to form a fine powder,

Step 6: The fine powder is finally reduced in a 10%H₂/He flow at 850° C. for 1 hour. These conditions are sufficient to convert the iron, nickel and copper oxides into the metallic state whereas the magnesium component remains in the oxide form.

The decomposition reactions of methane and CO/H₂ were carried out according to similar procedures in a quartz flow reactor heated by a Lindberg horizontal tube furnace. The gas flow to the reactor was precisely monitored and regulated by the use of MKS mass flow controllers allowing a constant composition of feed to be delivered. Powdered catalyst samples (50 mg) were placed in a ceramic boat at the center of the reactor tube in the furnace and the system flushed with argon for 0.5 hours. After reduction of the sample in a 10%H₂/Ar mixture at a temperature between 500 and 1000° C., the system was once again flushed with argon and the reactant gases were introduced into the reactor and allowed to react with the respective catalysts at a set temperature under atmospheric pressure conditions. The progress of the reaction was followed as a function of time by sampling both the inlet and outlet gas streams at regular intervals and analyzing the reactants and products by gas chromatography. The total amount of solid carbon deposited during the time on stream was determined gravimetrically after the system had been cooled to room temperature. In both systems this solid product was shown to consist exclusively of graphite nanofibers, there being no other forms of carbon present.

Samples of the solid carbon were subsequently characterized by a variety of techniques including high-resolution transmission electron microscopy, which enabled one to determine the structural and physical details of the nanofibers from lattice fringe images. X-ray diffraction analysis gave information on the degree of crystalline perfection and the spacing between adjacent graphite sheets constituting the material. Surface area measurements of the nanofibers were determined by N₂ adsorption at −196° C.

Following preparation, the “platelet” graphite nanofibers are subsequently treated in a flow reactor in the presence of an inert gas, such as argon to temperatures between 1100 and 3000° C. Following this treatment the edge regions of such materials undergo reaction that produces the fusion of adjacent layers and results in a “sealing action” of up to 10 neighboring graphite layers. These structures form folds of two, four, six, eight or ten walls.

When these modified “platelet” graphite nanofibers (carbon nanochips) are subsequently cleaved into smaller sections the resulting “chips” or slabs have cross-sectional dimensions in the range, 0.34 to 3.02 nm, where the lower limit width is significantly smaller than that of traditional SWNT. The average width of the “chips” is dependent upon the temperature at which the precursor “platelet” graphite nanofibers are treated. On the other hand, the distance between the inner adjacent walls of the nanochips is fixed at a distance of 0.34 nm, which is narrower than any other known carbon nanostucture. Also, the nanochips of the present invention will have from about 2 to 20, preferably about 2 to 16, and more preferably from about 2 to 10 graphite platelets aligned substantially perpendicular to the growth axis of the nanochip.

Cleaving of the carbon nanochips into discrete sections can be achieved by various methods, including sonication of a dispersion of the material in an aqueous solution or organic liquid. A further method involves heating the carbon nanochips in air at temperatures from about 500 to 700° C. for about 1 min, following treatment of the materials in an oxidizing environment that could consist of ozone, hydrogen peroxide, potassium permanganate or a mixture consisting of concentrated sulfuric acid and concentrated nitric acid at various temperatures to secure oxidation.

Samples of the carbon nanochips and the cleaved sections were characterized by a variety of techniques including high-resolution transmission electron microscopy, which enabled one to determine the structural and physical details of the samples from lattice fringe images. X-ray diffraction analysis gave information on the degree of crystalline perfection and the spacing between adjacent graphite sheets constituting the material. Surface area measurements of the nanochips and cleaved sections were determined by N₂ adsorption at -196° C.

The present invention will be illustrated in more detail with reference to the following examples, which should not be construed to be limiting in scope of the present invention.

### EXAMPLE 1

In this set of experiments “platelet” graphite nanofibers (P-GNF) have been treated in argon for a period of 1 hour at increasing temperatures and the surface area and average pore size of each sample determined by adsorption of N₂ at -1 96° C.

TABLE I

| | S.A. | Pore Size |
|---|---|---|
| Material | (m²/g) | (nm) |
| P-GNF 3000° C. | 44 | 11.4 |
| P-GNF 2800° C. | 28 | 15.3 |
| P-GNF 2330° C. | 40 | 13.2 |
| P-GNF 1800° C. | 50 | 11.8 |
| P-GNF | 80 | 6.3 |

Examination of the data presented in Table I show that following high temperature treatment of “platelet” graphite nanofibers in argon there is a progressive change in the physical characteristics of the material. As the temperature is raised from 20 to 2800° C. there is a gradual decrease in surface area and a concomitant increase in average pore size. At temperatures in excess of 2800° C., however, one observes a change in behavior. Under these conditions an increase in surface area and a corresponding drop in the pore size occur.

### EXAMPLE 2

In this series of experiments we have determined the average number of walls constituting the carbon nanochips as a function of treatment temperature in argon. Following treatment in argon at various temperatures for 1 hour the samples were examined by high-resolution transmission electron microscopy. From the micrographs it was possible to measure the number of walls in a given carbon nanochip and these data are presented in Table II. It is evident that as the treatment temperature is raised there is a progressive increase in the number of walls associated with the nanofibers.

TABLE 2

| | Average Number walls in |
|---|---|
| Material | Nanochips |
| P-GNF 3000° C. | 10 |
| P-GNF 2800° C. | 10 |
| P-GNF 2330° C. | 6 |
| P-GNF 1800° C. | 2 |
| P-GNF 1100° C. | 2 |

### EXAMPLE 3

The data given in Table 3 shows the comparison of the performance of various materials, including the current commercial system based on Fe,Cr,K oxides, for the catalyzed oxidative dehydrogenation of ethylbenzene (EB) at 500° C. Other reaction conditions were as follows: mole ratio 0₂/EB=0.86, EB flow rate=9.33 ×10⁻⁶ mol/min, He=9.8 cc/min, catalyst weight=40.5 mg. The data were taken 17 hours after the start of the reaction.

TABLE III

| | (%) EB | (%) ST | (%) ST | S.A. | Pore Size |
|---|---|---|---|---|---|
| Catalyst | conversion | selectivity | yield | (m²/g) | (nm) |
| P-GNF 2330° C. | 39.1 | 100.0 | 40.4 | 40 | 13.2 |
| P-GNF 1800° C. | 34.2 | 100.0 | 34.7 | 50 | 11.8 |
| P-GNF | 35.1 | 94.1 | 33.0 | 80 | 6.3 |
| XC-72 | 34.6 | 75.5 | 29.3 | 230 | 5.2 |
| Fe, Cr, K oxides | 6.9 | 75.9 | 5.2 | 4.4 | 4.0 |

Examination of the results shows some significant features and highlights the superior performance of the “platelet” GNF that had been treated in argon at 2330° C., which is significantly better than that of the same type of GNF that had been heated to 1800° C. While both of these materials exhibited a 100% selectively towards styrene (ST), it is the generation of a higher pore size in the former that appears to be the critical factor. Indeed, when one considers all the data there appears to be a direct correlation between pore size and catalytic performance. In sharp contrast, the magnitude of the surface area of the materials does not have an impact on the catalytic behavior.

### EXAMPLE 4

In this series of experiments 10 wt.% Ag supported on various support media, carbon nanochips (GNF-P 2330) were reacted in a C₂H₄/O₂ (1:4) mixture at 220° C. at atmospheric pressure for 6 days. The product distribution, C₂H4 conversion and selectivity towards the desired product, ethylene oxide, were measured at regular intervals of this period of time and are compared in Table IV. It is evident that the current commercial catalyst, 10% Ag/α-alumina, exhibits an activity that is significantly higher than that of systems the metal is supported on most of the carbonaceous materials. The overall performance, however, is about a factor of 3 lower than that of the Ag/P-GNF 2330° C. (carbon nanochip) catalyst.

TABLE IV

| | % C₂H₄ | % C₂H₄O | % C₂H₄O |
|---|---|---|---|
| Catalyst | Conv. | selectivity | yield |
| 10% Ag/P-GNF 2330° c. | 26.17 | 46.65 | 12.21 |
| 10% Ag/P-GNF | 8.09 | 48.37 | 3.91 |
| 10% Ag/MWNT | 3.64 | 37.96 | 1.38 |
| 10% Ag/Graphite | 4.52 | 22.94 | 1.04 |
| 10% Ag/α-Al₂O₃ | 12.00 | 29.92 | 3.59 |

What is claimed is:

1. A graphitic nanostructure comprised of about 2 to about 20 graphite platelets aligned substantially perpendicular to the growth axis of the nanostructure.

2. The graphitic nanostructure of claim 1 wherein there are from about 2 to 10 graphite platelets aligned substantially perpendicular to the growth axis of the nanostructure.

3. The graphite nanostructure of claim 1 wherein the cross-sectional dimension ranges from about 0.34 to about 3.02 nm.

4. The graphite nanostructure of claim 3 wherein the cross-sectional dimension ranges from about 0.35 to about 0.75 nm.

5 A method for the production of highly conductive carbon nanochips comprised of a structure in which the walls are aligned in a direction parallel to the longitudinal axis and are separated by a fixed distance of 0.34 nm and the overall width of such structures can vary from 0.35 to 3.02 nm and having a crystallinity of greater than 99.5%, which method comprised treating a carbon nanostructure comprised of a plurality of graphite platelets that are aligned substantially perpendicular to the longitudinal axis of the nanostructure with a substantially inert gas at a temperature over the range 1100 to 3000° C.
